(19) United States
(12) Patent Application Publication
(10) Pub. No.: US 2006/0219203 A1
(43) Pub. Date: Oct. 5, 2006

(54) Two-stroke engine

(76) Inventor: Christian Kellermann, Stapelfeld (DE)

Correspondence Address: KELLY LOWRY & KELLEY, LLP, 6320 CANOGA AVENUE, SUITE 1650, WOODLAND HILLS, CA, 91367, US

(21) Appl. No.: 11/396,444

(22) Filed: Apr. 3, 2006

(30) Foreign Application Priority Data
Apr. 4, 2005 (DE) 20 2005 005 328.7

(51) Int. Cl. F02M 35/10

(52) U.S. Cl. 123/184.57

(57) ABSTRACT

In order to provide a two-stroke engine (100) which has an exhaust outlet (11) on the cylinder (10), with a silencer (12) arranged on the exhaust outlet (11), which silencer comprises a first chamber (13) and a second chamber (14) which are connected to the exhaust outlet (11) and through which exhaust gas produced in the cylinder (10) is able to flow, wherein the first chamber (13) is designed so that it is largely closed, and the exhaust gas can be guided through the second chamber (14) via an outlet on the silencer side into the open air, in which the disadvantages are avoided, and with which, in particular, a simple, compact unit is produced which at the same time effectively prevents damaging post-escape to the largest possible extent, it is proposed that the exhaust outlet (11) is designed with fixing means (16, 17, 18) on which a partition (15) is detachably arranged, which partition guides some of the exhaust gas into the first chamber (13) and some into the second chamber (14).

The invention relates to a two-stroke engine which has an exhaust outlet on the cylinder, with a silencer arranged on the exhaust outlet, which silencer comprises a first and second chamber which are connected to the exhaust outlet and through which an exhaust gas generated in the cylinder can flow, wherein the first chamber is designed so that it is largely closed, and the exhaust gas can be guided through the second chamber through the exhaust outlet into the open air.

It is generally known that devices are used on the two-stroke engine to reduce or avoid a damaging post-escape of an unburned fuel-air mixture. At too low an exhaust gas back-pressure too much fresh gas escapes into the exhaust system connected in series to the two-stroke engine, and at too high an exhaust back-pressure too little fresh gas reaches the engine cylinder. The two-stroke engine may be constructively designed so that at high speeds a high exhaust gas back-pressure is generated, but this is not achieved at low speeds. Here a method is known for matching the gas vibrations within a very close speed range (resonance speed) so that the damaging post-escape is reduced and the degree of filling improved.

According to DE-OS 29 27 521, a two-stroke internal combustion engine is known with a main outlet port arranged in the cylinder and an additional outlet port above the main outlet port. The additional outlet port is constructed so that it can be controlled by means of a control mechanism. This ensures that the outlet cross-section can be controlled according to the operating conditions, so that both high peak outputs are possible with a large outlet cross-section, and a wide speed range is possible due to a speed- and load-dependent reduction in the outlet cross-section. Furthermore, DD-PS 2 28 57 discloses a two-stroke internal combustion engine in which a resonance chamber is connected to and disconnected from the outlet duct. Control is speed- and load-dependent by means of a piston loaded by the exhaust gas pressure of the outlet duct. In the lower load range the resonance chamber is constantly connected because it produces improved effects therein. On the other hand, the resonance chamber is disconnected in the upper load range with the aid of the rising exhaust gas pressure, thereby preventing output losses. The disadvantage is that the devices described are very expensive to design.

According to DE 562 560 a two-stroke internal combustion engine is described which has exhaust slots controlled by the cylinder. The exhaust slots are in this case divided into sub-ducts by the installation of several thin plates, wherein the partial flows are dispersed separately through pipes. Vibrations, pressure fluctuations and disturbing noises may therefore be reduced. However, the risk of unburned fuel-air mixture being discharged into the pen air cannot unfortunately be avoided.

DE-PS 570 510 discloses an internal combustion engine with a silencer, wherein separate spaces, the first of which is closed, are associated with the swept volume of the cylinder by the movement of the piston inside the cylinder. In this case the silencer has a closed and throttled space leading to the open air, which spaces are added one after the other to the swept volume, thereby enabling silencing to be achieved by suitable matching of the relative sizes of the spaces to each other. Unfortunately this device requires a large design space, and cannot always be used effectively in the area of two-stroke internal combustion engines.

For a general understanding reference is also made to DE 1 174 579 A1 and DE 199 56 157 A1.

The object of this invention is to provide a two-stroke engine in which the disadvantages mentioned are avoided, and with which, in particular, a simple, compact unit is formed which at the same time largely avoids a damaging post-escape.

To achieve this objective a two-stroke engine is proposed with the characteristics of Claim 1. Preferred further developments are described in the dependent claims.

For this purpose provision is made according to the invention for the exhaust outlet to be constructed with fastening means on which is detachably arranged a partition which guides some of the exhaust gas into the first chamber and some into the second chamber. Unlike the two-stroke engines of prior art, this invention is characterised in particular in that it is of simple construction and can be assembled at low cost. The partition is preferably secured by a positive and/or non-positive connection in the exhaust gas outlet, through which the exhaust gas formed in the cylinder is guided into the silencer without requiring expensive connecting elements and/or processes. Moreover, the partition may also be detached quickly, e.g. for maintenance work on the two-stroke engine. A further advantage is that differently designed silencers may be arranged on the two-stroke engine. The only important condition here is that the partition arranged on the silencer is reliably retained by fastening means.

The partition may on the one hand be connected integrally to the silencer. In a further possible design of the invention the partition may be secured to the side of the silencer facing the cylinder, as an additional component. During the operation of the two-stroke engine some of the exhaust gas flows through the exhaust gas outlet into the first chamber, which acts as a buffer chamber.

The working stroke of the internal combustion engine is not impeded by the exhaust gas flowing into the buffer chamber. If the piston reaches the partition during its downward movement with the upper piston edge, the exhaust gas still present in the combustion chamber can escape into the silencer and can be discharged into the open air. As soon as the buffer chamber reseals toward the cylinder during the subsequent compression stroke of the pistons, the remaining exhaust gas still present in the buffer chamber can escape through the opening arranged between the buffer chamber and silencer into the silencer, and reduce the pressure in the buffer chamber.

Here it is particularly advantageous for the opening arranged between the buffer volume and the silencer to be arranged in the region of the connecting pipe between the cylinder and buffer volume.

The other advantage of this invention is that the “exhaust gas post-treatment” just described can easily be added to existing two-stroke engines without incurring high costs. It is only necessary to arrange the corresponding fixing means in the region of the exhaust gas outlet.

In an alternative design the silencer may of course consist of several buffer chambers, in which case the buffer volume and stroke volume may be similarly dimensioned, for example. It is also possible to vary the volume ratio according to certain technical requirements. It has been demonstrated that the two-stroke engine according to the invention is particularly suitable for use in hand-guided working implements.

Provision is also made, according to the invention, for the fixing means for the partition to be designed as grooves which are arrange don the lateral wall of the exhaust outlet. The exhaust outlet suitably has two grooves which run in opposite directions to one another. The partition is inserted in the grooves which reliably retain the lateral regions of the partition in the installed position. Here the grooves guarantee that the partition cannot be disturbed by any vibrations and that a defined installation position can be reached. To ensure that the partition is reliably retained in the grooves, the groove width is suitably adapted to the thickness of the partition.

A further measure for improving the invention provides that the partition terminates at a certain distance from the combustion space of the cylinder. Stop elements may be provided on the groove, for example, for this purpose. In one possible design the groove runs from the side facing the silencer along the lateral wall of the exhaust outlet, which is advantageously designed as a duct, and terminates at a certain distance from the combustion space of the cylinder. This design protects the cylinder, with pistons, from any damage resulting from a partition projecting too widely into the combustion space.

For structural reasons it may be advantageous for the fixing means to be designed as projections which project into the exhaust gas outlet duct, onto which are pushed the partition, for example. The partition suitably consists of a metal and is preferably designed as an elastic, thin plate. To achieve good fixing of the plate it is adapted to the shape of the projections in its lateral regions. In one possible design, the lateral region of the plate is U-shaped. Obviously other geometrical design alternatives are conceivable for the projection and the lateral region of the plate.

According to a possible further development of the invention it is proposed that the fixing means be designed as a hole into which the partition can be secured by twisting or snapping into position. The hole alone also services, in this design, as the exhaust gas outlet duct which provides a satisfactory retention of the partition because of its geometry. After the partition is inserted in the hole, at a suitable angle, merely twisting the partition about the longitudinal axis of the exhaust gas outlet duct is required for the partition to clamp with its lateral region against the hole wall. The hole is preferably provided with stop surfaces with which the partition remains in contact when fixed.

According to an advantageous design of the invention provision may be made for the plate to remain under a certain initial tension inside the exhaust outlet, e.g. for reliable retention of the in order to prevent the plate from vibrating during operation of the two-stroke engine.

Provision may also be made, according to the invention, for two separating plates to be incorporated in the grooves, these plates being clamped against each other and lying one upon the other roughly in the shape of an arc.

In a further possible design of the invention suitable initial tension may also be generated by allowing the grooves to assume a slightly arc-shaped course along the extension of the exhaust outlet. When the partition is pushed into the arc-shaped groove it is simultaneously being and is therefore put under an initial tension. Alternative geometric groove courses, such as a wave-shaped design, are also possible.

A further measure to improve the invention provides that a catalytic converter for exhaust treatment is arranged in the first and/or second chamber, thus enabling the pollutants from the two-stroke engine to be considerably reduced.

The exhaust inlet cross-section on the first chamber may vary in design, according to the engine operating points, in order to improve the buffer action at certain operating points. In this case the cross-section of the opening of the first chamber can be achieved by means of a throttle valve actively connected to a servomotor, which uses the motor speed or motor load as a reference value, for example.

Further advantages, characteristics and details of the invention may be deduced from the following description, in which embodiments of the invention are described in detail with reference to the drawings. Here the characteristics mentioned in the claims and in the description may be essential to the invention either individually or in any combination. In a purely diagrammatic representation:

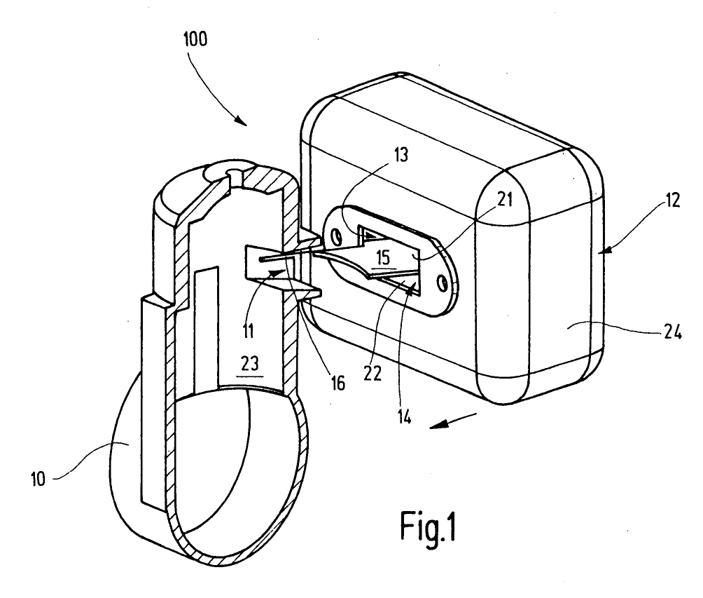

FIG. 1 shows a three-dimensional view of a two-stroke engine with an emission-reducing silencer shortly before its installation,

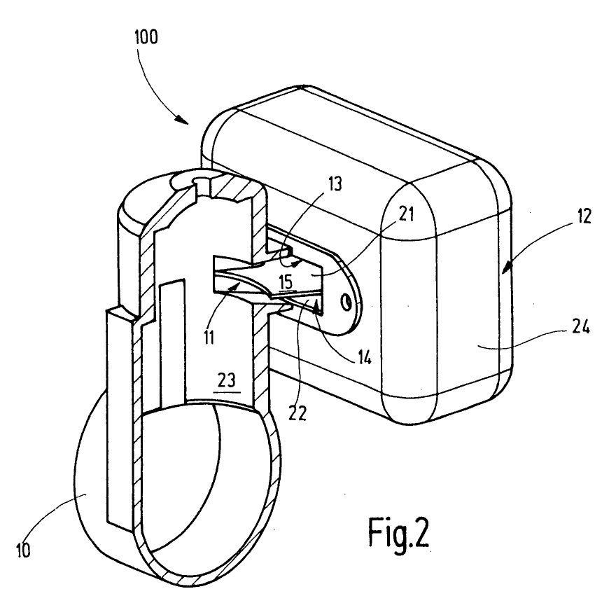

FIG. 2 shows a two-stroke engine to which is secured a silencer,

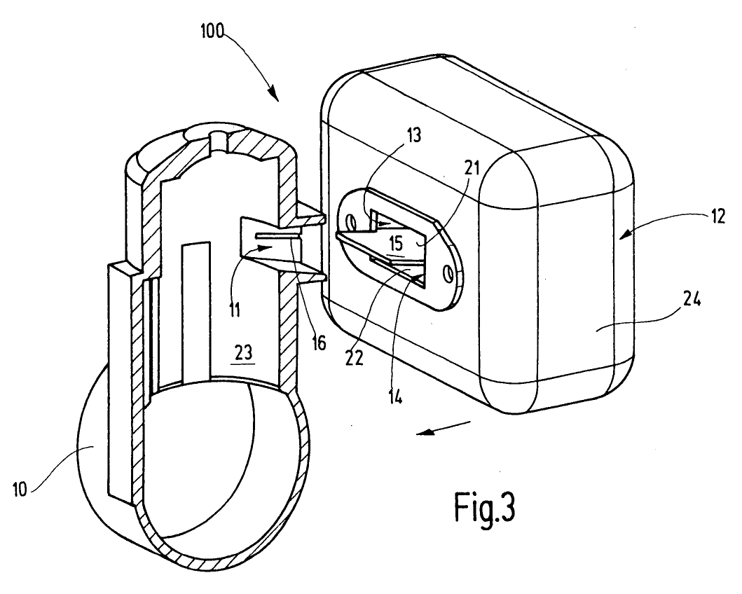

FIG. 3 shows an alternative design of a two-stroke engine with a silencer,

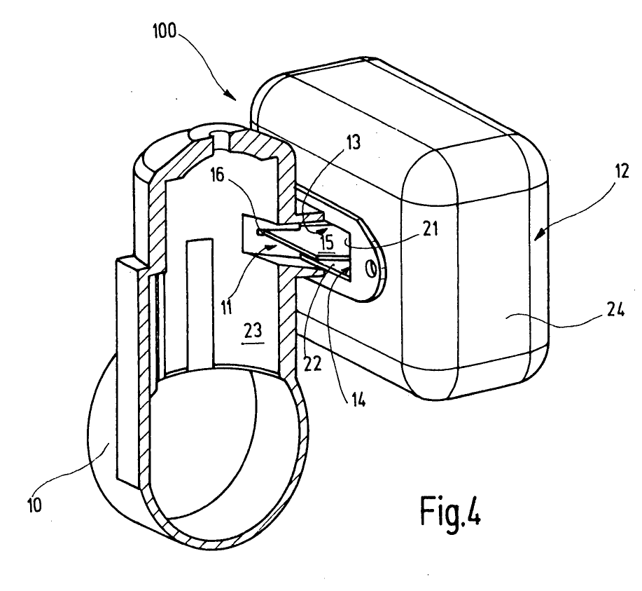

FIG. 4 shows the two-stroke engine according to FIG. 3, where the silencer is arranged on the two-stroke engine,

FIG. 5 shows a side elevation of the exhaust outlet with separating plate inserted,

FIG. 6 shows an alternative design of the exhaust outlet, with separating plate inserted,

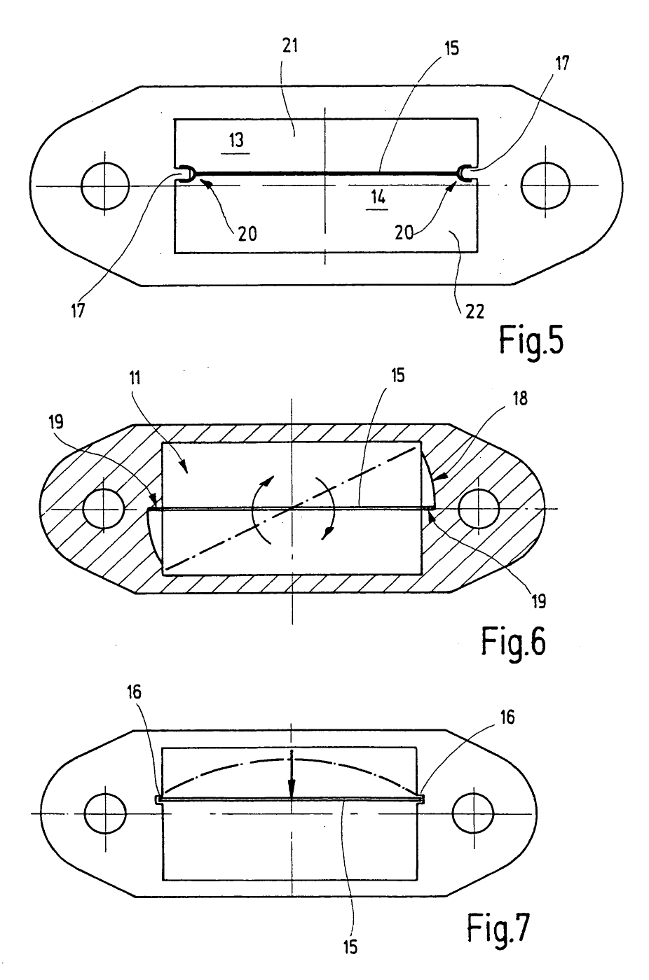

FIG. 7 shows a further alternative of the exhaust outlet with separating plate inserted,

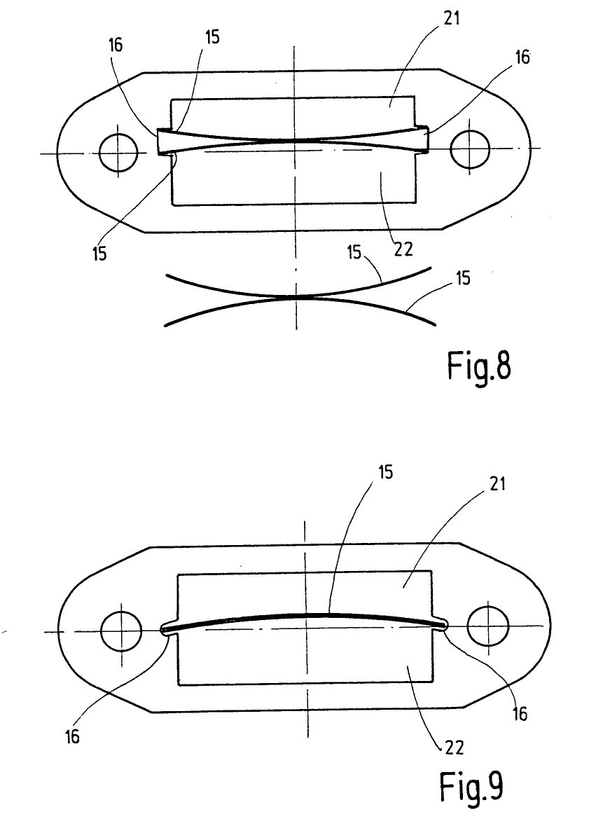

FIG. 8 shows a further embodiment of an exhaust outlet in which two separating plates are secured,

FIG. 9 shows an alternative design of the exhaust outlet with separating plate secured,

FIG. 10 shows a further possible design of an exhaust outlet with silencer,

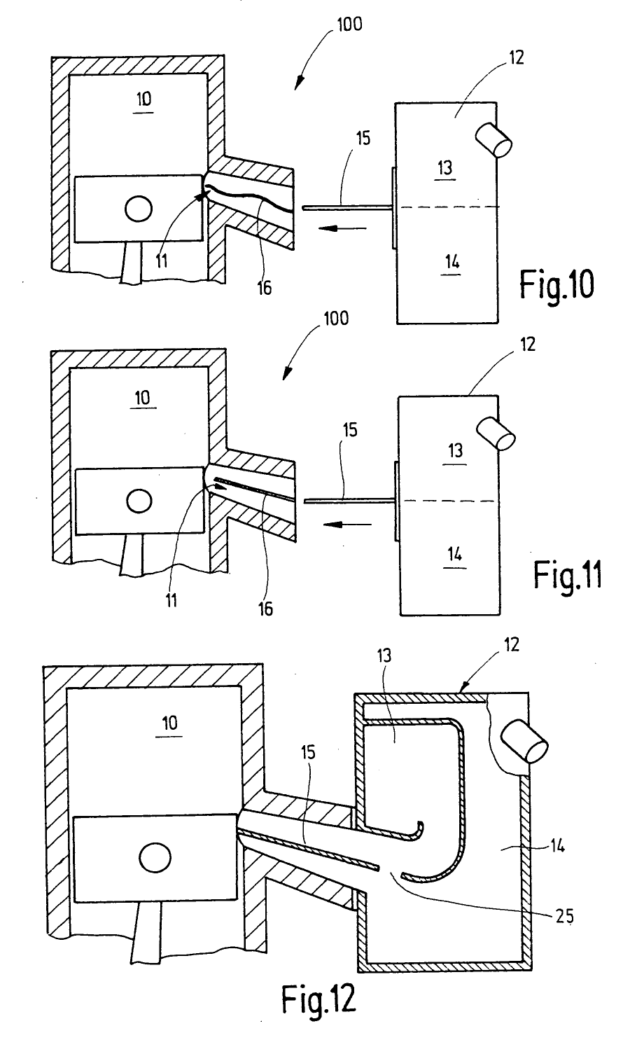

FIG. 11 shows an additional design alternative of an exhaust outlet with silencer, and

FIG. 12 shows a further possible design of an exhaust outlet with silencer.

FIG. 1 shows a cylinder 10 of a two-stroke engine 100, with a swept volume 23 in which the piston moves, and with an exhaust outlet 11 which has the shape of a duct. The lateral duct wall has fixing means 126 in the form of two grooves (16 (only one groove 16 is shown because of the sectional representation), wherein groove 16 terminates at a certain distance from swept volume 23. On cylinder 10 may be fitted a silencer 12, which has a first chamber 13 and a second chamber 14, which are surrounded by a common housing wall 24. First chamber 13 and second chamber 14 are separated from each other by a wall, not shown, which lies inside housing wall 24. Here a bypass, not shown either, may be provided between the two chambers. Silencer 12 has an inlet opening which is divided by a partition 15, thus forming an upper opening 21 and a lower opening 22. Upper opening 21 is connected to first chamber 13, acting as a buffer chamber, and lower opening 22 is connected to second chamber 14. Partition 15 is a metal plate 15.

According to the arrow direction shown in FIG. 1, partition 15 is pushed into groove 16 of exhaust outlet 11 for securing to two-stroke engine 100. During the operation of two-stroke engine 100 the exhaust gas formed in swept volume 23 flows through exhaust outlet 11 along partition 15 and through opening 21, then into buffer chamber 13. Since buffer chamber 13 is designed so that it is closed, the exhaust as flows back through upper opening 21 into cylinder 10, thereby generating a flow which largely prevents unburned fresh gases from reaching the air through silencer 12. The burned fuel-air mixture is fed through lower opening 22 into second chamber 14 of silencer 12, and is then discharged into the open air.

The two-stroke engines 100 shown in FIGS. 2 to 4 correspond essentially to two-stroke engine 100 shown in FIG. 1, which is why only the differences are examined in the following. In FIG. 2 partition 15 is already inserted in groove 16 of exhaust outlet 11, partition 15 extending as far as swept volume 23. In the embodiment shown partition 15 has a partially circular recess on the side facing swept volume 23, so that the piston moving in cylinder 10 cannot knock against partition 15.

In contrast to FIGS. 1 and 2, partition 15 according to FIGS. 3 and 4 is constructed straight on the side facing swept volume 23. In this design it is important for groove 16 to terminate at a certain distance from swept volume 23 to guarantee free mobility of the piston inside cylinder 10.

FIG. 5 shows a further design of the invention in which fixing means 17 are designed as projections 17 which project into the opening of exhaust outlet 11. To achieve reliable fixing of separating plate 15 on projections 17, lateral regions 20 of separating plate 15 are adapted to the shape of projections 17. In this embodiment lateral regions 20 have a U-shaped design.

In another possible design exhaust outlet 11 is provided with a hole 18 which is shown by way of example in FIG. 6. Separating plate 15 is first inserted in hole 18 by the worker, at a certain angle, and is then twisted in the direction of the arrow indicated in FIG. 6 until separating plate 15 rests against stop surfaces 19 of hole 18. In this position separating plate 15 is retained in exhaust outlet 11 with a certain tension.

In FIG. 7 separating plate 15 is brought by deformation to its end position in which separating plate 15 assumes a certain initial tension, as in FIG. 6.

According to FIG. 8 two separating plates 15 are arranged in grooves 16 of exhaust outlet 11, which grooves lie clamped against each one above the other. Also shown are upper opening 21 for first chamber 13, and lower opening 22 for second chamber 14.

In the embodiment shown in FIG. 9 grooves 16 are of a slightly arc-shaped construction along the extension of exhaust outlet 11, so that separating plate 15 also experiences initial tension when inserted.

IN FIG. 10 groove 16 has a wave-shaped construction along the extension of exhaust outlet 11, so that separating plate 15 is reliably retained in the secured position on two-stroke engine 100. As FIG. 10 shows, silencer 12 is guided to the left, when assembled, in the direction of duct-shaped exhaust outlet 11.

In FIG. 11 clamping of separating plate 15 is achieved by means of a non-aligned groove 16.

The embodiment shown in FIG. 12 is a special active combination of exhaust outlet and silencer design. Here a bypass opening 25 is arranged between buffer chamber 13 incorporating the buffer volume and second chamber 14 in partition 15 in silencer 12, through which opening the remaining exhaust gas still present in the buffer chamber can escape into the silencer, during the compression stroke and sealing of the buffer chamber, and is able to reduce the pressure in the buffer chamber.

### LIST OF REFERENCES

100 Engine
10 Cylinder
11 Exhaust outlet
12 Silencer
13 First chamber (buffer chamber)
14 Second chamber
15 Partition, separating plate
16 Fixing means, groove
17 Fixing means, projection
18 Fixing means, hole
19 Stop surfaces
20 Lateral region of the partition
21 Upper opening
22 Lower opening
23 Swept volume
24 Housing wall
25 Bypass opening

1. A two-stroke engine (100) which has, on the cylinder (10), an exhaust outlet (11), with a silencer (12) arranged on the exhaust outlet (11), which silencer comprises a first chamber (13) and a second chamber (14), which are connected to the exhaust outlet (11) and through which exhaust gas produced in the cylinder (10) is able to flow, wherein the first chamber (13) is designed so that it is largely closed, and the exhaust gas can be guided through the second chamber (14) via an outlet on the silencer side into the open air:
characterised in that the exhaust outlet (11) is constructed with fixing means (16, 17, 18) on which a partition (15) is detachably arranged, which partition guides some of the exhaust gas into the first chamber (13), and some into the second chamber (14).

2. The two-stroke engine according to claim 1, characterised in that the partition (15) is secured positively and/or non-positively to the fixing means (16, 17, 18).

3. The two-stroke engine according to claim 1, characterised in that the fixing means (16) are designed as groves (16) which are arranged on the lateral wall of the exhaust outlet (11).

4. The two-stroke engine according to claim 3, characterised in that the exhaust outlet (11) has two grooves (16) which are arranged opposite each other.

5. The two-stroke engine according to claim 2, characterised in that the partition (15) terminates at a certain distance from the combustion space (23) of the cylinder (10).

6. The two-stroke engine according to claim 1, characterised in that the fixing means (17) are designed as projections (17).

7. The two-stroke engine according to claim 6, characterised in that the partition (15) comprises a plate (15) which is adapted in its lateral regions (20) to the projections (17).

8. The two-stroke engine according to claim 7, characterised in that the lateral regions (20) of the plate (15) have a U-shaped design.

9. The two-stroke engine according to claim 1, characterised in that the fixing means (18) is designed as a hole (18) into which the partition (15) may be secured by twisting.

10. The two-stroke engine according to claim 9, characterised in that the hole (18) has stop surfaces (19) for the peripheral region of the partition (15).

11. The two-stroke engine according to claim 1, characterised in that the partition (15) is under initial tension.

12. The two-stroke engine according to claim 3, characterised in that two separating plates (15) are incorporated in the grooves (16), wherein the separating plates (15) are clamped against each other and lie one upon the other roughly in the shape of an arc.

13. The two-stroke engine according to claim 12, characterised in that the grooves (16) are designed roughly in the shape of an arc along the extension of the exhaust outlet (11).

14. The two-stroke engine according to claim 3, characterised in that grooves (16) have a wave-shaped course.

15. The two-stroke engine according to claim 1, characterised in that a catalytic converter is arranged in the first chamber (13) for exhaust post-treatment.

16. The two-stroke engine according to claim 1, characterised in that the second chamber (14) has an exhaust inlet port (21) which is variable in its cross-section.

17. The two-stroke engine according to claim 1, characterised in that the first chamber (13) has an exhaust inlet opening (21) which is variable in its cross-section.

18. The two-stroke engine according to claim 17, characterised in that the cross-section of the exhaust inlet opening (21) is designed so that it is variable according to the engine speed.

19. The two-stroke engine according to claim 1, characterised in that the first chamber (13) and the second camber (14) are connected by at least one bypass pipe (25).
